(19) United States
(12) Patent Application Publication
(10) Pub. No.: US 2004/0223333 A1
(43) Pub. Date: Nov. 11, 2004

(54) Continuously adjustable illuminating apparatus

(76) Inventors: Tzu-Hsiung Lee, Taipei City (TW); Cheng Hao Lin, Hsinchu City (TW); Devon Shyu, Kuei Jen Hsiang (TW)

Correspondence Address: BIRCH STEWART KOLASCH & BIRCH, PO BOX 747, FALLS CHURCH, VA, 22040-0747, US

(21) Appl. No.: 10/606,763

(22) Filed: Jun. 27, 2003

(30) Foreign Application Priority Data
May 9, 2003 (TW) 092208529

(51) Int. Cl. F21S 8/00

(52) U.S. Cl. 362/424; 362/524; 362/427

(57) ABSTRACT

A continuously adjustable illuminating apparatus includes a base, a light source, a reflector and a continuously adjustable mechanism. The base has a through hole, and the light source movably passes through the through hole and emits light rays. The reflector surrounds the base and is mounted to the base to collect the light rays and reflects the light rays for output. The continuously adjustable mechanism may continuously move the light source so as to continuously adjust a relative position between the light source and the reflector.

### BACKGROUND OF THE INVENTION

1. Field of the Invention

The invention relates to an illuminating apparatus, and more particularly to an illuminating apparatus having an illuminating angle that may be continuously adjusted.

2. Description of the Related Art

A typical headlamp for a vehicle mainly adopts a light bulb having two tungsten wires or adopts two light bulbs to switch between the high beam and the low beam. However, the light bulb with two tungsten wires cannot provide high brightness with low power consumption. On the other hand, the way using two light bulbs may additionally need another lamp cover, and the cost of the headlamp cannot be effectively lowered.

FIGS. 1 and 2 show a conventional vehicle headlamp using a solenoid to switch between the high beam and the low beam. Referring to FIG. 1, a conventional vehicle headlamp 100 includes a base 101, a light tube 102, a solenoid 103, a spring 104, and a reflector 105. The base 101 is formed with a through hole 106 through which the light tube 102 passes. The light rays emitted from the light tube 102 are reflected by the reflector 105 for output. Adjusting the relative position between the light tube 102 and the reflector 105 may switch between the high beam and the low beam. The solenoid 103 adjusts the position of the light tube 102 in two steps so as to adjust the relative position between the light tube 102 and the reflector 105 and cause the switching operations between the high beam and the low beam. The spring 104 provides an elastic force for pushing the light tube 102 upward and back to its original position when the solenoid is disabled. If the state as shown in FIG. 1 is the low beam state, in which the solenoid 103 is disabled and the light tube 102 is relatively far away from the base 101, the state as shown in FIG. 2 is the high beam state, in which the solenoid 103 overcomes the elastic force of the spring 104 and attracts the light tube 102 downward to make the light tube 102 relatively close to the base 101.

FIG. 3 is a schematic illustration showing an illuminating range of the conventional vehicle headlamp. As shown in FIG. 3, the main light spot of the vehicle headlamp 100 in the low beam mode is focused on P1 while the main light spot in the high beam mode is focused on P2. The user may only adjust the main light spot to either P1 or P2, and cannot adjust the main light spot to other positions except for P1 and P2. When the speed of the vehicle is kept equal to or lower than, for example, 40 km/hr, the low beam can provide sufficient illuminance. When the speed of the vehicle is kept greater than or equal to, for example, 100 km/hr, and no other vehicles are present within a predetermined distance in front of the vehicle, the low beam cannot provide sufficient illuminance and it is preferred to switch the low beam to the high beam in order to provide better illuminance.

When the speed of the vehicle is kept at, for example, 70 km/hr and no other vehicles are present within a predetermined distance in front of the vehicle, it is preferred to use a middle beam between the high beam and the low beam. In addition, when the vehicle is running on the mountain road, the user may need an illuminating mode that provides nearer illumination than the low beam. However, the prior art cannot satisfy the above-mentioned requirement. A typical vehicle may have a continuously adjustable rearview mirror for various users to adjust. However, no vehicle has a continuously adjustable vehicle headlamp for the user to adjust according to various conditions.

Moreover, when the vehicle is running, the solenoid for controlling the high beam and the low beam may not work normally and cause error operations when the road is not smooth enough. In addition, when the high beam of the prior art has to be used for a long time, the solenoid has to be always powered on, thereby wasting the power consumption.

### SUMMARY OF THE INVENTION

It is therefore an object of the invention to provide a continuously adjustable illuminating apparatus for the user to continuously adjust the illuminating condition of the illuminating apparatus according to various situations.

Another object of the invention is to provide a continuously adjustable illuminating apparatus capable of effectively avoiding errors in operation and saving electric power.

To achieve the above-mentioned objects, the invention provides a continuously adjustable illuminating apparatus including a base, a light source, a reflector, and a continuously adjustable mechanism. The base has a through hole, and the light source movably passes through the through hole and emits light rays. The reflector surrounds the base and is mounted to the base to collect the light rays and reflects the light rays for output. The continuously adjustable mechanism may continuously move the light source so as to continuously adjust a relative position between the light source and the reflector.

According to one aspect of the invention, the continuously adjustable mechanism may include a cam driven to rotate and to move the light source, a gear set composed of a worm shaft and a worm wheel to drive the cam to rotate, and a motor for driving the gear set.

According to another aspect of the invention, the continuously adjustable mechanism may include a nut fixed to the base, a screw rod fitted into the nut and driven to rotate and to move the light source, and a motor for driving the screw rod to rotate.

According to still another aspect of the invention, the continuously adjustable mechanism may include a rack fixed to the light source, a pinion engaging with the rack and driven to rotate and to move the light source, and a motor for driving the pinion to rotate.

### BRIEF DESCRIPTION OF THE DRAWINGS

FIGS. 1 and 2 show a conventional vehicle headlamp using a solenoid to switch between the high beam and the low beam.

FIG. 3 is a schematic illustration showing an illuminating range of the conventional vehicle headlamp.

FIG. 4 is a schematic illustration showing an illuminating range of an illuminating apparatus of the invention.

FIG. 5 is a schematic illustration showing an illuminating apparatus according to a first embodiment of the invention.

FIG. 6 shows a first state of the illuminating apparatus according to the first embodiment of the invention.

FIG. 7 shows a second state of the illuminating apparatus according to the first embodiment of the invention.

FIG. 8 shows a third state of the illuminating apparatus according to the first embodiment of the invention.

FIG. 9 is a schematic illustration showing an illuminating apparatus according to a second embodiment of the invention.

FIG. 10 is a schematic illustration showing an illuminating apparatus according to a third embodiment of the invention.

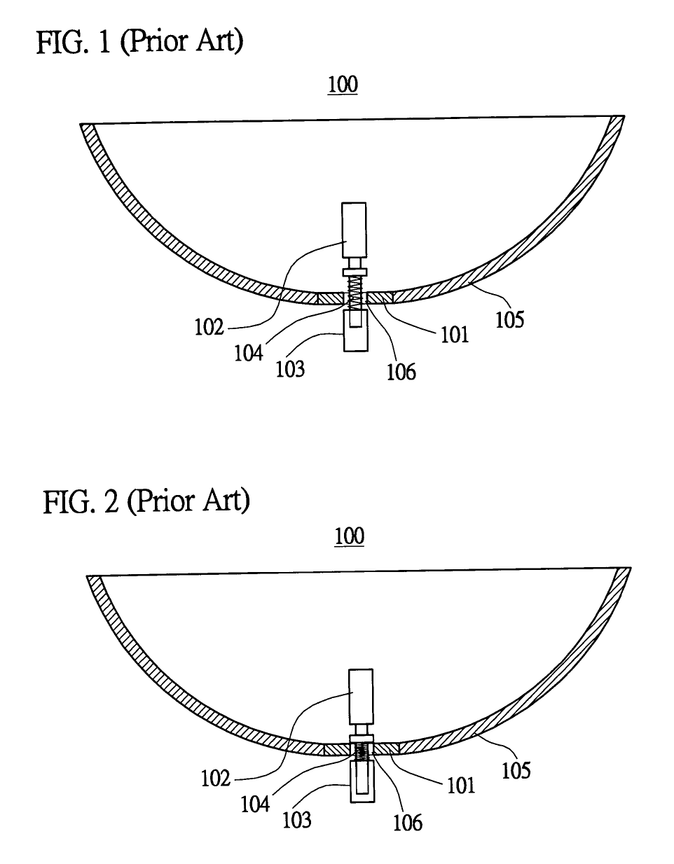

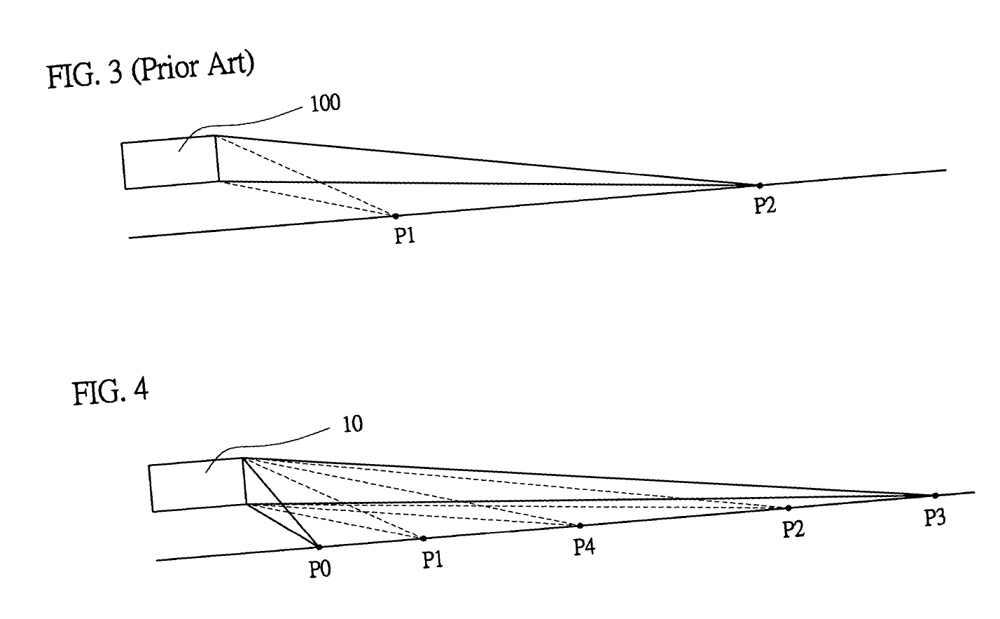

### DETAILED DESCRIPTION OF THE INVENTION

Although the invention is started from the design of the vehicle headlamp, the invention also may be applied to other illumination apparatuses, such as fog lamps, artistic lamps, searchlight lamps, and the like.

FIG. 4 is a schematic illustration showing an illuminating range of an illuminating apparatus of the invention. As shown in FIG. 4, the illuminating range of the main light rays of the illuminating apparatus 10 of the invention is between the light spots P0 and P3, and may be adjusted to an arbitrary point (e.g., P4) between P0 and P3 in response to various requirements. Consequently, the illuminating range may be enlarged and the illuminating angle may be variegated.

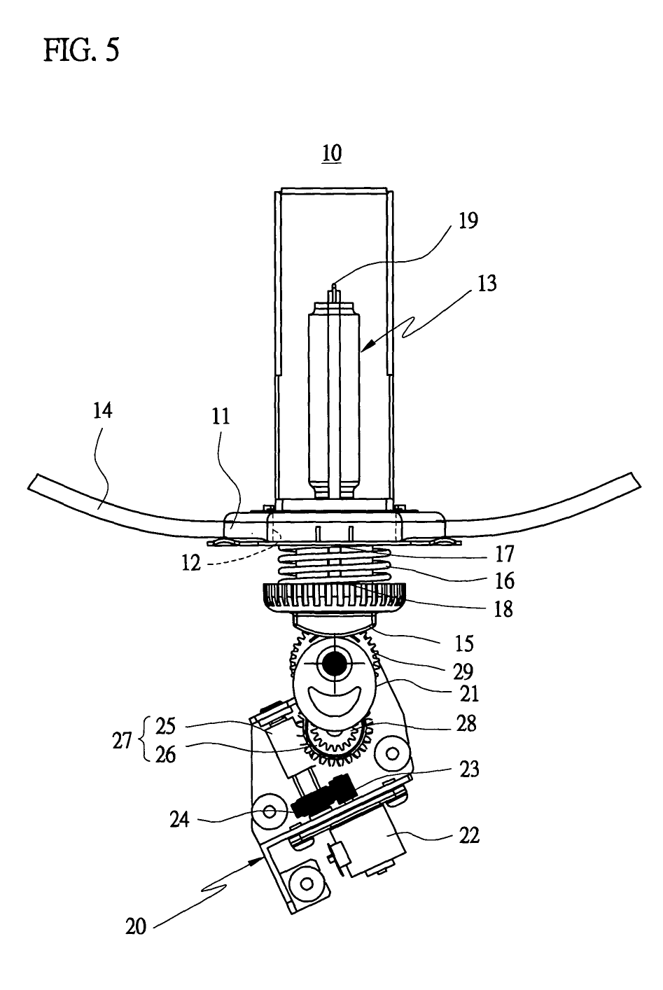

FIG. 5 is a schematic illustration showing an illuminating apparatus according to a first embodiment of the invention. Referring to FIG. 5, the continuously adjustable illuminating apparatus 10 includes a base 11, a light source 13, a reflector 14, and a continuously adjustable mechanism 20. The base 11 has a through hole 12. The light source 13, which may be a light bulb, a light tube, or the like, movably passes through the through hole 12 and emits light rays. The reflector 14 surrounds the base 11 and is mounted to the base 11 to collect the light rays and reflects the light rays for output. The continuously adjustable mechanism 20 may continuously move the light source 13 so as to continuously adjust a distance between a top 19 of the light source 13 and the base 11, i.e., to adjust a relative position between the light source 13 and the reflector 14.

The light source 13 has a follower 15, and the continuously adjustable illuminating apparatus 10 further includes a spring 16. The light source 13 partially passes through the spring 16. The spring 16 has a first end 17 in contact with the base 11 and a second end 18 in contact with the follower 15.

The continuously adjustable mechanism 20 has a motor 22 for driving gears 23 and 24, a worm shaft 25, a worm wheel 26, gears 28 and 29, and a cam 21 to rotate sequentially. The cam 21 is driven to rotate and to push the follower 15 and the light source 13 to move. The spring 16 keeps the follower 15 always in contact with the cam 21. The effects of the continuously adjustable illuminating apparatus 10 may be achieved by properly designing the profile of the cam 21.

In addition, the cam 21 also may be directly driven by the motor 22. Alternatively, the cam 21 also may be driven to rotate by the motor 22 that drives a gear set 27 composed of the worm shaft 25 and the worm wheel 26. Thus, the transmission mechanism is not limited to that as shown in FIG. 5.

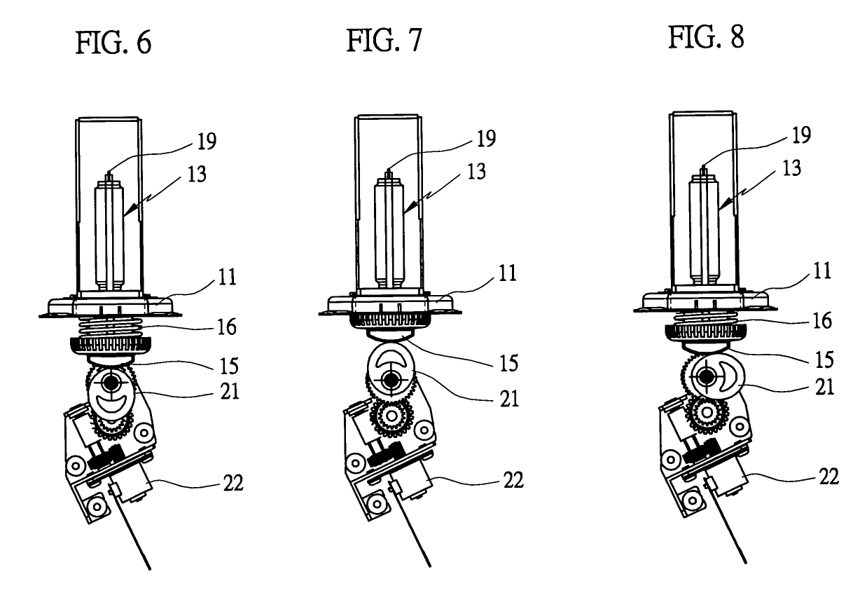

FIGS. 6 to 8 show three states of the illuminating apparatus according to the first embodiment of the invention. As shown in FIG. 6, the contact state between the cam 21 and the follower 15 minimizes the distance between the base 11 and the top 19 of the light source 13 as well as the compression amount of the spring 16. As shown in FIG. 7, the contact state between the cam 21 and the follower 15 maximizes the distance between the base 11 and the top 19 of the light source 13 as well as the compression amount of the spring 16. As shown in FIG. 8, the contact state between the cam 21 and the follower 15 makes the distance between the base 11 and the top 19 of the light source 13 range between the maximum value and the minimum value, and makes the compression amount of the spring 16 range between the maximum amount and the minimum amount.

Consequently, controlling the rotation of the motor 22 may control the position of the light spot of the main light rays. Although the motor 22 may rotate counterclockwise and clockwise in this embodiment, the motor 22 may rotate only counterclockwise or clockwise in other embodiments so as to simplify the circuit design.

Furthermore, according to the combination of the worm shaft 25 and the worm wheel 26, the continuously adjustable mechanism 20 is free from error operations owing to great vibrations, and the motor 22 need not to be always powered on.

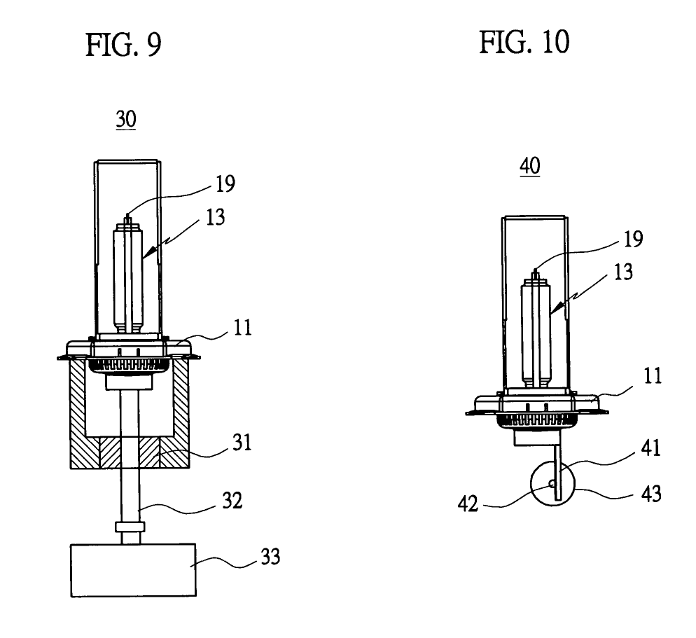

In addition to the continuously adjustable mechanism using the cam, other continuously adjustable mechanisms may be adopted. FIG. 9 is a schematic illustration showing an illuminating apparatus according to a second embodiment of the invention. Referring to FIG. 9, a continuously adjustable mechanism 30 of the illuminating apparatus of this embodiment includes a nut 31, a screw rod 32, and a motor 33. The nut 31 is fixed to the base 11, the screw rod 32 fitted into the nut 31 is driven to rotate and to move the light source 13. The motor 33 drives the screw rod 32 to rotate so as to adjust the distance between the base 11 and the top 19 of the light source 13 accordingly.

FIG. 10 is a schematic illustration showing an illuminating apparatus according to a third embodiment of the invention. Referring to FIG. 10, a continuously adjustable mechanism 40 of the illuminating apparatus of this embodiment includes a rack 41, a pinion 42 and a motor 43. The rack 41 is fixed to the light source 13, and the pinion 42 engages with the rack 41 and is driven to rotate and to move the light source 13. The motor 43 drives the pinion 42 to rotate so as to adjust the distance between the base 11 and the top 19 of the light source 13 accordingly.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A continuously adjustable illuminating apparatus, comprising:
a base having a through hole;
a light source movably passing through the through hole to emit light rays;
a reflector surrounding the base and mounted to the base to collect the light rays and reflect the light rays for output; and
a continuously adjustable mechanism for continuously moving the light source so as to continuously adjust a relative position between the light source and the reflector.

2. The continuously adjustable illuminating apparatus according to claim 1, wherein the continuously adjustable mechanism comprises:
a cam driven to rotate and to move the light source.

3. The continuously adjustable illuminating apparatus according to claim 2, wherein the continuously adjustable mechanism further comprises:
a motor for driving the cam to rotate.

4. The continuously adjustable illuminating apparatus according to claim 2, wherein the continuously adjustable mechanism further comprises:
a gear set for driving the cam to rotate; and
a motor for driving the gear set.

5. The continuously adjustable illuminating apparatus according to claim 4, wherein the gear set comprises:
a worm shaft driven by the motor; and
a worm wheel driven by the worm shaft.

6. The continuously adjustable illuminating apparatus according to claim 2, wherein the light source has a follower in contact with the cam.

7. The continuously adjustable illuminating apparatus according to claim 6, further comprising a spring, the light source partially passing through the spring, wherein the spring has a first end in contact with the base, and a second end in contact with the follower.

8. The continuously adjustable illuminating apparatus according to claim 1, wherein the continuously adjustable mechanism comprises:
a nut fixed to the base;
a screw rod fitted into the nut, the screw rod being driven to rotate and to move the light source accordingly; and
a motor for driving the screw rod to rotate.

9. The continuously adjustable illuminating apparatus according to claim 1, wherein the continuously adjustable mechanism comprises:
a rack fixed to the light source;
a pinion engaging with the rack, the pinion being driven to rotate and to move the light source accordingly; and
a motor for driving the pinion to rotate.
